(19) United States
(12) Patent Application Publication
(10) Pub. No.: US 2025/0100231 A1
(43) Pub. Date: Mar. 27, 2025

(54) INTEGRATED MOLDED BODY

(71) Applicant: TORAY Industries, Inc., Tokyo (JP)

(72) Inventors: Keisuke SHIOZAKI, Nagoya-shi, Aichi (JP); Hiroyuki NAKAYAMA, Nagoya-shi, Aichi (JP)

(73) Assignee: TORAY Industries, Inc., Tokyo (JP)

(21) Appl. No.: 18/832,526

(22) PCT Filed: Jan. 30, 2023
(86) PCT No.: PCT/JP2023/002838

§ 371 Date: Jul. 24, 2024

(30) Foreign Application Priority Data
Feb. 9, 2022 (JP) 2022-018450

(51) Int. Cl. B29C 65/48; B29L 31/34

(52) U.S. Cl. CPC B29C 65/4815; B29K 2995/0097; B29L 2031/3481

(57) ABSTRACT

An integrated molded body includes: a laminate including a prepreg layer consist of a continuous fiber and a resin; and a resin member integrated with the laminate, in which in the laminate, one surface in a thickness-direction is on a design surface side, and a surface opposite to the surface on the design surface side is on a non-design surface side, the laminate has a through-hole penetrating in the thickness-direction, and the resin member has a part having an exposed surface from the through-hole of a design surface side outer layer of the laminate, and an overlapping part with the laminate, the overlapping part being bonded to a non-design surface side outer layer of the laminate.

### TECHNICAL FIELD

The present invention relates to an integrated molded body that is used as a component or a casing portion of, for example, personal computers, OA devices, mobile phones, or the like and that is suitable for applications requiring lightweight, high strength, and high stiffness as well as thinning.

### BACKGROUND ART

There has been a growing demand for high designed electronic devices such as personal computers, OA devices, AV devices, mobile phones, telephones, facsimiles, home electric appliances, and toy products. In order to meet the requirements, it is required to improve the degree of freedom in design of a product design surface.

Patent Document 1 discloses a configuration in which a slit is formed on a design surface side of a sandwich structure including a core material, and the core material is compressed to form a concave upper portion having a sharp contour.

Patent Document 2 discloses a configuration in which a through-hole is provided in a sheet shaped body to impart designability as a punch pattern.

### PRIOR ART DOCUMENTS

### Patent Documents

Patent Document 1: Japanese Patent Laid-open Publication No. 2019-098634
Patent Document 2: Japanese Patent Laid-open Publication No. 2010-253938

### SUMMARY OF THE INVENTION

### Problems to be Solved by the Invention

However, in Patent Document 1 and Patent Document 2, when a plurality of slits or through-holes are provided in forming slits or through-holes in a laminate constituting a sandwich structure or a sheet shaped body, there has been a problem that a certain distance needs to be provided between the slits or the through-holes in order to suppress burrs and chipping of fibers of a base material used in the laminate at the time of processing.

An object of the present invention is to provide an integrated molded body having high designability by imparting a shape having a higher degree of freedom in design to such a conventional technique.

### Solutions to the Problems

In order to solve the above problems, an integrated molded body according to the present invention has the following configurations. That is:
(1) An integrated molded body including: a laminate including a prepreg layer consist of a continuous fiber and a resin; and a resin member integrated with the laminate,
in which in the laminate, one surface in a thickness-direction is on a design surface side, and a surface opposite to the surface on the design surface side is on a non-design surface side,
the laminate has a through-hole penetrating in the thickness-direction, and
the resin member has a part having an exposed surface from the through-hole of a design surface side outer layer of the laminate, and an overlapping part with the laminate, the overlapping part being bonded to a non-design surface side outer layer of the laminate.
(2) The integrated molded body according to (1), in which a minimum thickness Tb of the overlapping part is 0.2 mm or more.
(3) The integrated molded body according to (1) or (2), in which a portion having a minimum thickness Tb of the overlapping part is formed at a position farthest in an in-plane direction from a wall surface of the through-hole of the laminate.
(4) The integrated molded body according to (3), in which a ratio Tb/Ta between a maximum thickness Ta (mm) and the minimum thickness Tb (mm) of the overlapping part is larger than 0 and smaller than 1.
(5) The integrated molded body according to any one of (1) to (4), in which a total thickness of the laminate and the overlapping part in a bonding region between the laminate and the overlapping part is thinner than a thickness of the laminate in a non-bonding region with the overlapping part.
(6) The integrated molded body according to any one of (1) to (5), having a unevenness area on a surface of a part including the exposed surface.
(7) The integrated molded body according to (6), in which a maximum depth of a recess of the unevenness area is 0.1 mm or more and 10 mm or less from a surface on the design surface side.
(8) The integrated molded body according to any one of (1) to (7), in which one or two or more frame members disposed on an outer circumferential part of the laminate and the resin member are integrated.
(9) The integrated molded body according to any one of (1) to (8), having a notch in a wall surface of the through-hole in the laminate.
(10) The integrated molded body according to any one of (6) to (9), in which the unevenness area is provided with a design different from a surrounding portion, and the unevenness area forms a character or a pattern.
(11) The integrated molded body according to (10), in which the unevenness area forms a logo.
(12) The integrated molded body according to any one of (1) to (11) that is used as an electronic equipment casing.

### Effects of the Invention

According to the present invention, it is possible to obtain an integrated molded body having a high degree of freedom in surface design, and for example, a logo or the like of an electronic equipment casing can be formed on a unevenness area provided on a surface of a resin member to exhibit higher designability.

### BRIEF DESCRIPTION OF THE DRAWINGS

FIG. 1 is a schematic perspective view of an integrated molded body 10 according to an embodiment of the present invention.

FIG. 2 is a schematic cross-sectional view in the thickness direction of the integrated molded body 10 as viewed along the line A-A′ in FIG. 1.

FIG. 3 is a schematic cross-sectional view in the thickness direction of the integrated molded body 10 as viewed along the line A-A′ in FIG. 1 in the case where a core layer 22 including a porous base material is provided and a thin section 24 is provided in the laminate 20.

FIG. 4 is a schematic cross-sectional view in the thickness direction of the integrated molded body 10 as viewed along the line A-A′ in FIG. 1 in the case where a region from a portion having the minimum thickness to a portion having the maximum thickness of a resin member 40 in an overlapping part 60 is formed into a curved surface.

FIG. 5 is a schematic cross-sectional view in the thickness direction of the integrated molded body 10 as viewed along the line A-A′ in FIG. 1 in the case where a notch 70 is provided in a wall surface of a through-hole 30 on a design surface side in the laminate 20.

FIG. 6 is a schematic cross-sectional view in the thickness direction of the integrated molded body 10 as viewed along the line A-A′ in FIG. 1 in the case where the notch 70 is provided in the wall surface of the through-hole 30 on a non-design surface side in the laminate 20.

FIG. 7 is a schematic cross-sectional view in the thickness direction of the integrated molded body 10 as viewed along the line B-B′ in FIG. 1 in the case where two types of frame members are arranged on the outer circumferential part of the laminate 20, and one of the two types of frame members has a shape continuous with the resin member 40 in some azimuths in the in-plane direction.

FIG. 8 is a schematic perspective view of the integrated molded body 10 having the through-hole 30 in a plane of the laminate 20 in the present invention.

### EMBODIMENTS OF THE INVENTION

Hereinafter, embodiments will be described with reference to the drawings. The present invention is not limited to the drawings or Examples.

An integrated molded body according to the present invention is formed by integrating a laminate and a resin member, and the laminate includes a prepreg containing continuous fibers and a resin as a component constituting a layer, and examples thereof include a laminate of prepregs. Alternatively, those having a structure in which a core layer such as a foamed molded body and a porous base material is sandwiched between prepregs as described later are also preferably used.

In the laminate, one surface in the thickness-direction is on a design surface side. The surface itself of the laminate may be a design surface, or as described later, another base material may be further provided on the surface of the laminate to form a design surface. A side opposite to the design surface side of the laminate in the thickness-direction is a non-design surface, and the laminate has a through-hole passing through the design surface to the non-design surface in the thickness-direction as shown in FIG. 8.

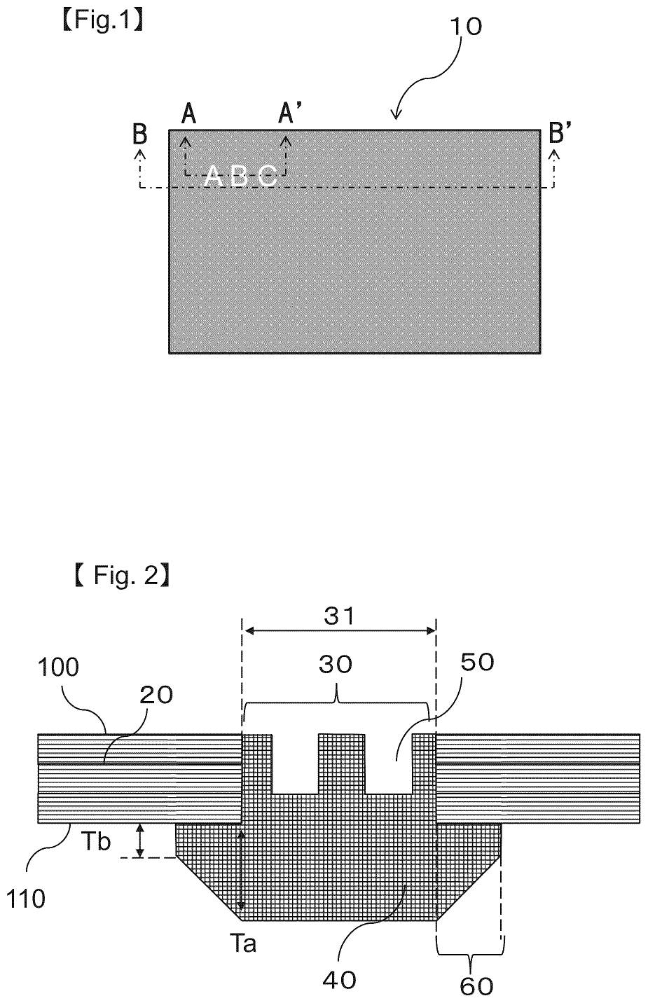

The resin member is a member integrated with the laminate, and in an example in which the resin member is integrated, the appearance from the design surface side is as shown in FIG. 1 and in FIGS. 2 to 7 viewed along the line A-A′ in FIG. 1. The resin member exists on the wall surface of the through-hole in the laminate and has a part including a surface exposed from the design surface side outer layer of the laminate and an overlapping part bonded to the non-design surface side outer layer of the laminate. The part existing between the exposed surface and the overlapping part is preferably bonded to the wall surface of the through-hole. The resin member contains a resin or a resin composition and may be composed only of a resin or a resin composition, and may contain fibers, particles, or the like according to needs. However, it is not preferable to use a configuration that hinders provision of the later-described unevenness area on the exposed surface, such as a configuration in which unidirectional fibers are arranged without gaps in the resin or the resin composition. The types preferably used as the resin are as described later.

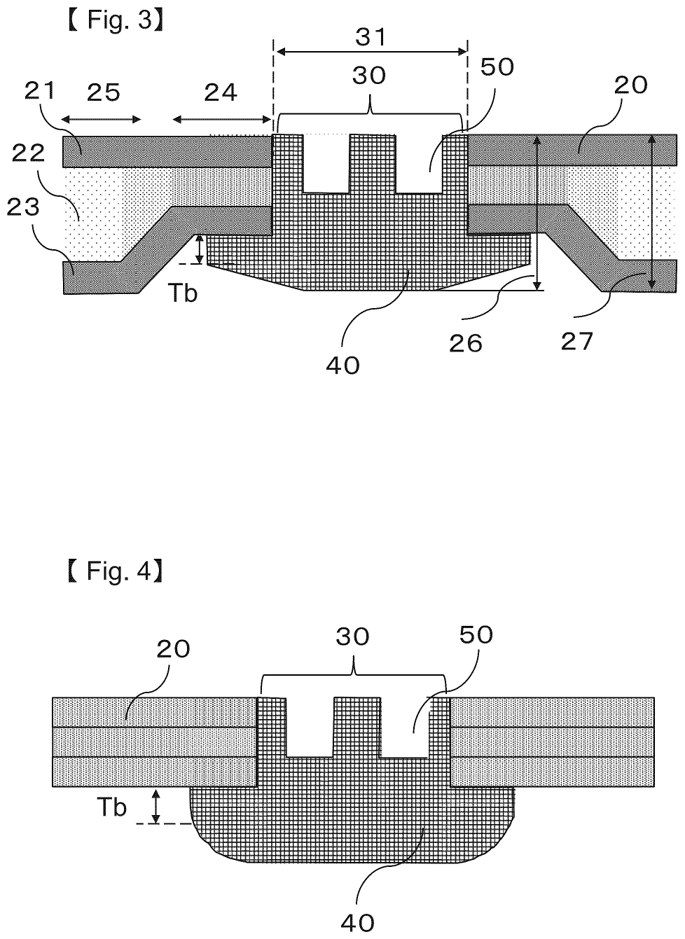

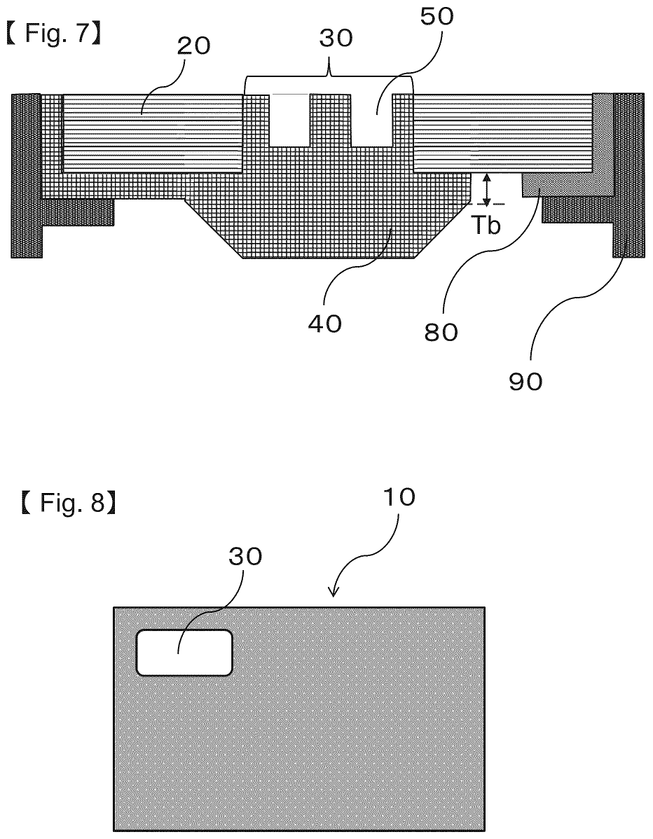

As shown in FIG. 2, an integrated molded body 10 according to the present invention has a configuration in which a resin member 40 is bonded to a through-hole 30 provided in a laminate 20. The configuration of the laminate 20 may be determined according to the application or the required performance of the integrated molded body 10, which may be a configuration of including a core layer 22 in an inner layer as illustrated in FIG. 3 to be described later, and a configuration of disposing a frame member on an outer circumferential part of the laminate 20 as illustrated in FIG. 7 to be described later.

A plurality of through-holes 30 may be provided in the plane of the laminate 20, and the advantages of the present invention can be favorably utilized. In addition, the shape of the through-hole 30 is not particularly limited but may be determined according to a required design property, application, and a required shape such as a circular shape, a polygonal shape such as a triangular shape and a quadrangular shape, and an arc shape. In addition, the corner portion of the through-hole 30 when the integrated molded body is viewed from the out-of-plane direction is preferably rounded from the viewpoint of bonding to the resin member, and the size of the radius is preferably 0.2 mm or more and 30 mm or less. From the viewpoint of processing productivity, it is more preferably 0.3 mm or more and 10 mm or less, still more preferably 0.5 mm or more and 1.0 mm or less.

In addition, the cross-sectional area of the through-hole 30 is preferably 1 to 1,000 mm², more preferably 100 to 900 mm², still more preferably 200 to 800 mm² per one through-hole 30 from the viewpoint of the stiffness and mass of the integrated molded body 10.

The direction of the minimum width of the through-hole 30 is not specified, and the minimum width is preferably 1 mm or more, more preferably 5 to 100 mm, still more preferably 10 mm to 50 mm from the viewpoint of moldability with an injection resin.

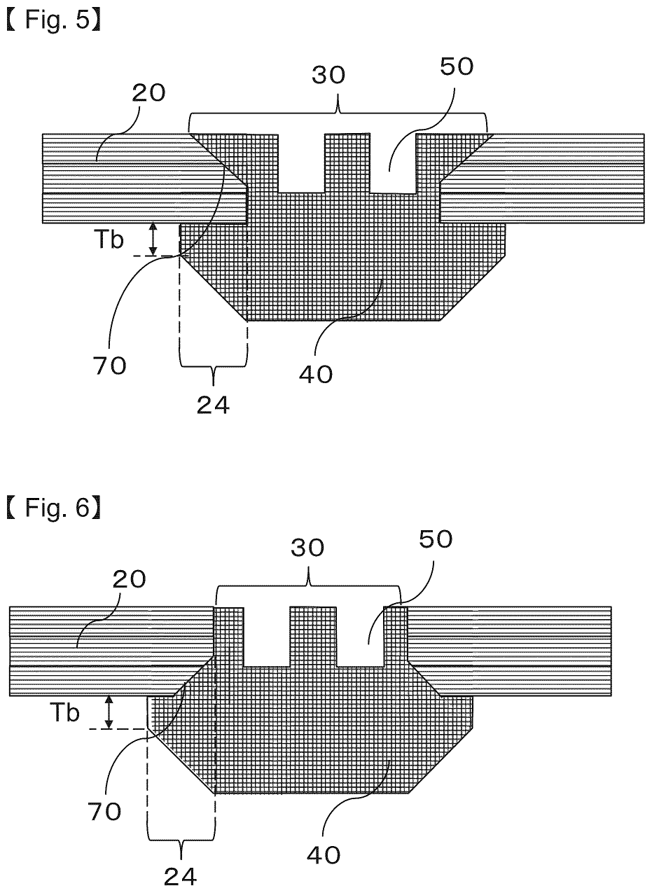

The integrated molded body of the present invention preferably has a notch in a wall surface of the through-hole in the laminate. An example of the integrated molded body having a notch in a wall surface of the through-hole is shown in FIGS. 5 and 6. As illustrated in FIGS. 5 and 6, regarding the shape of the through-hole 30, a notch 70 may be provided on the wall surface of the through-hole 30 of the laminate 20. When the notch 70 is provided in the wall surface of the through-hole 30 on the design surface side as shown in FIG. 5, the resin member 40 sandwiches the laminate 20, and the bonding strength can be improved. In addition, when the notch 70 is provided on the wall surface of the through-hole 30 on the non-design surface side as shown in FIG. 6, the flowability of the resin can be improved without increasing the resin height of the overlapping part.

The integrated molded body of the present invention preferably has a unevenness area on a surface of a part including the exposed surface. When the unevenness area 50 is provided in the thickness-direction of the laminate 20 at a part including the exposed surface on the design surface side of the resin member 40, high designability can be imparted to the integrated molded body.

In the integrated molded body of the present invention, the unevenness area is preferably provided with a design different from a surrounding portion, and the unevenness area preferably forms a character or a pattern. Specifically, in order to impart a color, pattern, character, or gloss to the unevenness area, high designability can be imparted by performing decoration such as painting and attaching a seal. In the integrated molded body of the present invention, the unevenness area preferably forms a logo. When the unevenness area is used to form the logo, the logo having higher visibility can be formed.

In the integrated molded body of the present invention, a maximum depth of a recess of the unevenness area is preferably 0.1 mm or more and 10 mm or less from a surface on the design surface side. The depth of the recess of the unevenness area is more preferably 0.2 mm or more and 3 mm or less from the viewpoint of the strength of the unevenness, still more preferably 0.3 mm or more and 1.5 mm or less from the viewpoint of designability. When there are a plurality of recesses and the depths of the recesses are different from each other, the depth of the deepest recess is defined as the depth of the recess.

As shown in FIG. 2, the resin member 40 has a part including an exposed surface from the design surface side of the laminate 20 and an overlapping part that is a bonding part with the surface on the non-design surface side of the laminate 20. Further, as shown in FIG. 7, a configuration in which the frame member is integrated may be employed. In the aspect shown in FIG. 7, the frame member The fiber mass are integrated at a surrounding part (portion shown on the left side in the drawing) on the non-design surface.

Here, continuous fibers and discontinuous fibers are defined. The continuous fibers are reinforcing fibers contained in the integrated molded body that are substantially continuously arranged over the entire length or the entire width of the integrated molded body. The discontinuous fibers are reinforcing fibers that are divided and placed. In general, fibers in a unidirectional fiber-reinforced resin in which reinforcing fibers arranged in one direction are impregnated with a resin correspond to continuous fibers. Fibers in a base material of a sheet molding compound (SMC) base material used for press molding or a pellet material containing reinforcing fibers and used for injection molding correspond to discontinuous fibers. Continuous fibers mean reinforcing fibers continuous over a length of at least 100 mm or more. The continuous fibers are preferably continuous at least over a length of 100 mm or more in one direction.

In the present invention, it is preferable to use carbon fibers as the continuous fibers constituting the prepreg, and hereinafter, the fibers are referred to as continuous carbon fibers. For the continuous carbon fibers, carbon fibers (including graphite fibers) excellent in specific strength and specific stiffness such as polyacrylonitrile (PAN)-based carbon fibers, rayon-based carbon fibers, lignin-based carbon fibers, and pitch-based carbon fibers are preferably used from the viewpoint of the weight reduction effect. In particular, in the present invention, it is also preferable to use PAN-based carbon fibers and the above-mentioned other carbon fibers in combination from the viewpoint of costs.

As the continuous carbon fibers, continuous carbon fibers having a tensile modulus preferably in the range of 200 to 1,000 GPa can be used from the viewpoint of the stiffness of the laminate 20, and more preferably, continuous carbon fibers having a tensile modulus in the range of 280 to 900 GPa can be used from the viewpoint of the handleability of the prepregs. When the tensile modulus of the carbon fibers is less than 200 GPa, the stiffness of a sandwich structure may be poor, and when the tensile modulus of the carbon fibers is more than 1,000 GPa, the crystallinity of the carbon fibers needs to be enhanced, which makes it difficult to produce carbon fibers. It is preferred that the tensile modulus of the carbon fibers is within the above range from the viewpoint of further improving the stiffness of the sandwich structure and improving the productivity of carbon fibers. The tensile modulus of the carbon fibers can be measured by a strand tensile test described in JIS R 7301-1986.

The density of the carbon fibers used for the continuous carbon fibers is preferably 1.6 g/cm³ or more and 2.0 g/cm³ or less in the case of PAN-based carbon fibers, 1.8 g/cm³ or more and 2.0 g/cm³ or less from the viewpoint of improving stiffness, 2.0 g/cm³ or more and 2.5 g/cm³ or less in the case of pitch-based carbon fibers, 2.0 g/cm³ or more and 2.3 g/cm³ or less from the viewpoint of costs.

The resin included in the prepregs is not limited to a particular resin, and a thermoplastic resin or a thermosetting resin can be used. In the case of a thermoplastic resin, for example, the same type of resin as that of the thermoplastic resin included in the core layer 22 described later can be used. As the thermosetting resin, thermosetting resins such as an unsaturated polyester resin, a vinyl ester resin, an epoxy resin, a phenol (resol type) resin, a urea melamine resin, a polyimide (PI) resin, a maleimide resin, and a benzoxazine resin can be preferably used. Two or more of these resins may be blended and used. Among them, an epoxy resin is particularly preferable from the viewpoint of mechanical properties and heat resistance of the molded body. The epoxy resin is preferably contained as a main component of the resin to be used, because its excellent mechanical properties are exhibited. Specifically, the epoxy resin is preferably contained in an amount of 30 wt % or more per resin composition.

The fiber massed content of the continuous carbon fibers included in the prepregs is preferably 30 to 70 wt % from the viewpoint of moldability and buckling characteristics of the laminate 20. When the content is less than 30 wt %, it may be difficult to achieve the buckling strength of the laminate 20. When the content is more than 70 wt %, the resin may be insufficient, thereby impairing the design after molding. More preferably, it is 62 to 68 wt %.

The thickness of each prepreg is preferably 0.05 to 1.00 mm from the viewpoint of the thickness of the laminate 20. From the viewpoint of the degree of freedom in design, the thickness is more preferably 0.05 to 0.20 mm. When the thickness of each prepreg is less than 0.05 mm, handleability during production and lamination may be difficult.

In addition, when the laminate 20 is configured, two or more types of prepregs containing different reinforcing fibers or resins may be used for lamination, and it is preferable to determine the configuration in consideration of required characteristics, material availability, and costs.

The thickness of the laminate 20 is preferably 0.2 mm or more and 3.0 mm or less, more preferably 0.5 mm or more and 2.0 mm or less from the viewpoint of thinning and stiffness of the final product.

As illustrated in FIG. 3, a thickness difference in the plane may be imparted to the laminate 20. As shown in FIG. 3, by providing a thin section 24 and a thickened section 25 of the laminate 20 and bonding the thin section 24 and the resin member 40, it is possible to obtain an integrated molded body while suppressing reduction in stiffness due to thinning.

In the present invention, from the viewpoint of reducing the weight and obtaining high stiffness of the laminate 20, it is preferred that the laminate 20 has a sandwich structure with prepregs 21 being disposed on both sides of the core layer 22 as illustrated in FIG. 3.

As the core layer 22, it is preferred to use a foamed molded body or a porous base material. It is preferred that the foamed molded body be made of a foam resin, and the porous base material be a base material made of discontinuous fibers and a thermoplastic resin.

As the type of the resin in the case of using the foamed molded body for the core layer 22, the thermosetting resins and the thermoplastic resins described above can be used. Among them, a polyurethane resin, a phenol resin, a melamine resin, an acrylic resin, a polyethylene (PE) resin, a polypropylene (PP) resin, a polyvinyl chloride (PVC) resin, a polystyrene resin, an acrylonitrile-butadiene-styrene (ABS) resin, a polyetherimide (PEI) resin, or a polymethacrylimide resin can be suitably used. Specifically, to ensure lightness, it is preferred to use a resin having an apparent density smaller than that of the prepregs. In particular, a polyurethane resin, an acrylic resin, a PE resin, a PP resin, a PEI resin, or a polymethacrylimide resin can be preferably used. The exemplified resins may contain an impact resistance improver such as elastomer or a rubber component, another filler, or additive as long as the object of the present invention is not impaired. Examples thereof include inorganic fillers, flame retardants, conductivity imparting agents, crystal nucleating agents, ultraviolet absorbers, antioxidants, vibration suppressing agents, antibacterial agents, insect repellents, deodorants, coloring inhibitors, heat stabilizers, release agents, antistatic agents, plasticizers, lubricants, colorants, pigments, dyes, foaming agents, defoaming agents, and coupling agents.

In the case where a porous base material is used for the core layer 22, it is preferred to use a precursor including discontinuous fibers and a thermoplastic resin and heated and expanded in the thickness direction by spring back to form voids. That is, a molded body containing the discontinuous fibers and the thermoplastic resin included in the core layer 22 is heated and pressurized to a softening point or melting point of the resin or more, then pressurization is released, and the molded body is expanded by a restore force of returning to the original state, which is what is called spring back, upon releasing of the residual stress of the discontinuous fibers, whereby desired voids can be formed in the core layer 22. In the restoration process, suppressing the restoration behavior in a certain region by certain pressurization means or the like can keep the porosity at a low level.

Examples of the discontinuous fibers used for the core layer 22 include metal fibers such as aluminum fibers, brass fibers, and stainless steel fibers, glass fibers, PAN-based, rayon-based, lignin-based, or pitch-based carbon fibers and graphite fibers, organic fibers such as aromatic polyamide (PA) fibers, polyaramid fibers, polyparaphenylene benzobisoxazole (PBO) fibers, polyphenylene sulfide (PPS) fibers, polyester fibers, acrylic fibers, nylon fibers, and PE fibers, and silicon carbide fibers, silicon nitride fibers, alumina fibers, silicon carbide fibers, and boron fibers. These are used alone or in combination of two or more. Surface treatment may be applied to these fiber materials. Examples of the surface treatment include a metal adhesion treatment, a treatment with a coupling agent, a treatment with a sizing agent, and an additive attachment treatment. Among the above fibers, carbon fibers (including graphite fibers) such as PAN-based carbon fibers, rayon-based carbon fibers, lignin-based carbon fibers, and pitch-based carbon fibers are preferably used from the viewpoint of the light weight and stiffness. Among them, in the present invention, it is more preferable to use PAN-based carbon fibers excellent in productivity. The fiber mass content of the discontinuous fibers constituting the core layer 22 is preferably 5 to 75 wt %, and the mass content of the thermoplastic resin therein is preferably 25 to 95 wt %.

In the formation of the core layer 22, the proportion of the blending amount of the discontinuous fibers to the thermoplastic resin is one element for specifying the porosity. The method for obtaining the proportion of the blending amount of the discontinuous fibers to the thermoplastic resin from the molded article is not limited to a particular method, and for example, the proportion of the blending amount can be obtained by removing the resin component contained in the core layer 22 and measuring the mass of only the remaining discontinuous fibers. Examples of the method for removing the resin component contained in the core layer 22 include a dissolution method and a burn-out method. The mass can be measured using an electronic scale or an electronic balance. The size of the molding material to be measured is a square size of 100 mm×100 mm, the number of measurements is n=3, and the average value thereof can be used.

The proportion of the blending amount of the discontinuous fibers in the core layer 22 is more preferably 7 to 70 wt % and that of the thermoplastic resin is more preferably 30 to 93 wt %, still more preferably 20 to 50 wt % of the discontinuous fibers and 50 to 80 wt % of the thermoplastic resin, particularly preferably 25 to 40 wt % of the discontinuous fibers and 30 to 75 wt % of the thermoplastic resin. When the content of the discontinuous fibers is less than 5 wt % and that of the thermoplastic resin is more than 95 wt %, spring back is less likely to occur, and the porosity cannot be increased. This configuration may fail to provide regions having different porosities in the core layer 22, and the bonding strength between the laminate 20 and the resin member 40 may be reduced. When the content of the discontinuous fibers is more than 75 wt % and that of the thermoplastic resin is less than 25 wt %, the specific stiffness of the laminate 20 may decrease.

In the present invention, the number-average fiber length of the discontinuous fibers constituting the core layer 22 is preferably 0.5 to 50 mm. Setting the number-average fiber length of the discontinuous fibers to the above length can ensure formation of voids by spring back in the core layer 22. The number-average fiber length is more preferably 0.8 to 40 mm, still more preferably 1.5 to 20 mm, particularly preferably 3 to 10 mm. When the number-average fiber length is shorter than 0.5 mm, it may be difficult to form voids having a certain size or more. When the number-average fiber length is longer than 50 mm, it is difficult to randomly disperse the fibers from the fiber bundle at the time of production of the core layer 22, and the core layer 22 cannot generate sufficient spring back in some cases, thereby limiting the size of voids and reducing the bonding strength between the laminate 20 and the resin member 40.

As a method for measuring the fiber length of the discontinuous fibers, for example, there is a method of directly extracting discontinuous fibers from a discontinuous fiber group and measuring the fiber length by microscopic observation. When the resin is attached to the discontinuous fiber group, for example, the resin is dissolved from the discontinuous fiber group in a solvent that dissolves only the resin attached to the discontinuous fiber group, and the remaining discontinuous fibers are filtrated and measured by microscopic observation (dissolution method). When there is no solvent that dissolves the resin, for example, only the resin is burned off in a temperature range in which the discontinuous fibers are not oxidized and its weight is not reduced, to thereby separate the discontinuous fibers, and the separated fibers are measured by microscopic observation (burn-out method). Four hundred discontinuous fibers are randomly selected from the discontinuous fiber group, and the lengths thereof are measured in the order of 1 μm with an optical microscope, and then the fiber length and the proportion thereof can be obtained. When the method of directly extracting discontinuous fibers from a discontinuous fiber group is compared with the method of extracting the discontinuous fibers by the burn-out method or the dissolution method, no special difference is produced in the obtained results as long as the conditions are properly selected. Among these measurement methods, it is preferred to use the dissolution method in terms of a smaller mass change of the discontinuous fibers.

For the formation of the core layer 22, it is preferable to use the discontinuous fibers as a mat, and the discontinuous fiber mat is produced such that, for example, discontinuous fibers are previously dispersed in a fiber bundle shape and/or a monofilament shape.

Specifically, as a method of producing the discontinuous fiber mat, dry processes such as an airlaid method in which discontinuous fibers are dispersed with an air flow and formed into a sheet and a carding method in which discontinuous fibers are formed by mechanical combing and made into a sheet, and a wet process by the Radlite method in which discontinuous fibers are stirred in water and made into paper can be used.

Examples of means for bringing the discontinuous fibers closer to a monofilament shape include, in the dry process, a method of providing fiber-opening bars, a method of vibrating the fiber-opening bars, a method of providing fine (extra-fine) carding pins, and a method of adjusting the rotation speed of the carding machine, which can be combined, and in the wet process, a method of adjusting the stirring condition of the discontinuous fibers, a method of diluting the reinforcing fiber concentration in a dispersion, a method of adjusting the viscosity of the dispersion, and a method of suppressing a vortex flow when transferring the dispersion.

In particular, the discontinuous fiber mat is preferably produced by a wet process, and the proportion of the reinforcing fibers in the discontinuous fiber mat can be easily adjusted by increasing the concentration of input fibers or adjusting the flow speed (flow rate) of the dispersion and the speed of the mesh conveyor. For example, decreasing the speed of the mesh conveyor with respect to the flow speed of the dispersion makes the orientation of the fibers in the obtained mat made of discontinuous fibers less likely to be directed toward the pulling direction, and thus a bulky mat made of discontinuous fibers can be produced. The mat made of discontinuous fibers may include discontinuous fibers only, may include a mixture of discontinuous fibers with a matrix resin component having a powder or fiber shape, may include a mixture of discontinuous fibers with an organic or inorganic compound, or may include discontinuous reinforcing fibers that are r to each other with a resin component.

The type of the thermoplastic resin used for the core layer 22 is not limited to a particular type, and any of the thermoplastic resins described below can be used. Examples of the thermoplastic resin include polyester resins such as a polyethylene terephthalate (PET) resin, a polybutylene terephthalate (PBT) resin, a polytrimethylene terephthalate (PTT) resin, a polyethylene naphthalate (PEN resin), and a liquid crystal polyester resin; polyolefin resins such as a PE resin, PP, and a polybutylene resin; polyarylene sulfide resins such as a polyoxymethylene (POM) resin, a PA resin, and a PPS resin; fluorine-based resins such as a polyketone (PK) resin, a polyether ketone (PEK) resin, a polyether ether ketone (PEEK) resin, a polyether ketone ketone (PEKK) resin, a polyether nitrile (PEN) resin, and a polytetrafluoroethylene resin; crystalline resins such as a liquid crystal polymer (LCP); amorphous resins such as a styrene-based resin, a polycarbonate (PC) resin, a polymethyl methacrylate (PMMA) resin, a PVC resin, a polyphenylene ether (PPE) resin, a PI resin, a polyamideimide (PAI) resin, a PEI resin, a polysulfone (PSU) resin, a polyethersulfone resin, and a polyarylate (PAR) resin; phenol-based resins; phenoxy resins; thermoplastic elastomers such as a polystyrene-based resin, a polyolefin-based resin, a polyurethane-based resin, a polyester-based resin, a polyamide-based resin, a polybutadiene-based resin, a polyisoprene-based resin, a fluorine-based resin, and an acrylonitrile-based resin; and thermoplastic resins selected from copolymers and modified products thereof. Among them, a polyolefin resin is preferable from the viewpoint of the lightweight property of the obtained laminate 20, a PA resin is preferable from the viewpoint of the strength, and the use of a resin having a linear branched structure also improves the stiffness of the porous base material. Then, amorphous resins such as a PC resin, a styrene-based resin, and a modified PPE resin are suitably used from the viewpoint of surface appearance, a polyarylene sulfide resin is suitably used from the viewpoint of heat resistance, and a PEEK resin is suitably used from the viewpoint of continuous use temperature.

The exemplified thermoplastic resins may contain an impact resistance improver such as elastomer and a rubber component, another filler, or additives as long as the object of the present invention is not impaired. Examples thereof include inorganic fillers, flame retardants, conductivity imparting agents, crystal nucleating agents, ultraviolet absorbers, antioxidants, vibration suppressing agents, antibacterial agents, insect repellents, deodorants, coloring inhibitors, heat stabilizers, release agents, antistatic agents, plasticizers, lubricants, colorants, pigments, dyes, foaming agents, defoaming agents, and coupling agents.

In the present invention, when a porous base material is used for the core layer 22, the amount of the discontinuous fibers and the thermoplastic resin can be reduced by using the precursor composed of the discontinuous fibers and the thermoplastic resin as the core layer 22 by forming the precursor into a three-dimensional shape such as a wave shape without spring back as described above, and the weight can be further reduced.

In the present invention, it is preferred that the laminate 20 include at least two layers of prepregs made of at least continuous fibers and a thermoplastic resin or a thermosetting resin, and the total thickness be 0.3 mm or more and 2.0 mm or less. The total thickness refers to the thickness of the thickest portion of the laminate 20. If the thickness is less than 0.3 mm, there is a possibility of insufficient stiffness as the integrated molded body 10. When the total thickness exceeds 2.0 mm, lightness may be impaired. The total thickness is more preferably 0.7 mm or more and 1.5 mm or less from the viewpoint of stiffness and lightness.

The laminate 20 including a porous base material as the core layer 22 may have, as illustrated in FIG. 3, a step part made of a first flat portion and a second flat portion closer to the peripheral edge portion in the in-plane direction within the total thickness range. It is preferred that the step part have an inclined surface of 10° to 90° with respect to the in-plane direction of the first flat portion provided in the laminate 20. With the configuration having the step part, the thickness at a bonding portion with the resin member 40 and the frame member can be increased without changing the thicknesses of the resin member 40 and the frame member, and both improvement of the bonding strength and thinning of the integrated molded body 10 can be achieved from the viewpoint of improvement in flowability during injection molding.

In the present invention, a continuous fiber fabric base material may be disposed on the further outer side of at least one of the outermost layers of the laminate 20 to form a design surface. Disposing the fabric pattern on the design surface side can make the design of a product more attractive. In addition, it is preferred that the number of laminated prepregs included in the laminate 20, the type of carbon fibers, and the type of resins be appropriately combined according to the characteristics and costs required for the integrated molded body 10.

The continuous fiber fabric base material will be described. The continuous fiber fabric base material is a base material in which a continuous fiber bundle of continuous fibers is used as a warp and a weft, and two sets of yarns are interlaced at a right angle using a loom.

Examples of the fibers used for the continuous fiber fabric base material include metal fibers such as aluminum fibers, brass fibers, and stainless steel fibers, glass fibers, PAN-based, rayon-based, lignin-based, or pitch-based carbon fibers and graphite fibers, organic fibers such as aromatic PA fibers, polyaramid fibers, PBO fibers, PPS fibers, polyester fibers, acrylic fibers, nylon fibers, and PE fibers, and silicon carbide fibers, silicon nitride fibers, alumina fibers, silicon carbide fibers, and boron fibers. These are used alone or in combination of two or more. Surface treatment may be applied to these fiber materials. Examples of the surface treatment include a metal adhesion treatment, a treatment with a coupling agent, a treatment with a sizing agent, and an additive attachment treatment.

When carbon fibers are used for the continuous fiber fabric base material, carbon fibers (including graphite fibers) excellent in specific strength and specific stiffness, such as PAN-based carbon fibers, rayon-based carbon fibers, lignin-based carbon fibers, and pitch-based carbon fibers are preferably used from the viewpoint of the weight reduction effect. Among them, PAN-based carbon fibers excellent in processability are desirable.

The continuous fiber fabric base material is preferably at least one fabric, the continuous fibers of which are selected from plain weave, twill weave, satin weave, and satin weave. Using the continuous fiber fabric base material having characteristics in its fiber pattern can make the characteristic fiber pattern conspicuous, and disposing the continuous fiber fabric base material on the further outer side of the outermost layer (design surface side) can make the shape pattern of the continuous fiber fabric conspicuous and show a novel surface pattern. The continuous fiber bundle used for the base material is preferably 1K to 24K, more preferably 1K to 6K from the viewpoint of the stability of the fiber pattern during processing. In general, a continuous fiber bundle including 1,000 fibers is referred to as 1K, a continuous fiber bundle including 3,000 fibers is referred to as 3K, and a continuous fiber bundle including 12,000 fibers are referred to as 12K.

In the present invention, it is also preferable to use a sheet molding compound (SMC) composed of a bundle-like assembly of discontinuous reinforcing fibers and a resin on the further outer side of at least one of the outermost layers of the laminate 20, and a marble appearance pattern can be made conspicuous and a novel surface pattern can be expressed.

In the present invention, a thermoplastic resin layer can be provided by disposing a thermoplastic resin base material at least partially between the prepreg 21 and the resin member 40 in the laminate 20 or/and between the core layer 22 and the resin member 40, and the thermoplastic resin layer functions as an adhesive.

As the thermoplastic resin base material, for example, adhesives such as an acrylic adhesive, an epoxy adhesive, a styrene adhesive, a nylon adhesive, and an ester adhesive, a thermoplastic resin film, and a nonwoven fabric can be used. Regarding the material, using the same material as that of the resin member 40 can increase the bonding strength. The resin provided on the outermost layer of the prepregs 21 or the core layer 22 may not necessarily be the same resin as the adhesive used for the thermoplastic resin base material and is not limited to a particular resin as long as it has good compatibility, and it is preferred to select an optimum resin according to the type of the resin included in the resin member 40.

In the present invention, in the laminate 20 using the porous base material, as schematically shown in FIG. 3, from the viewpoint of the stiffness and the thinness of the integrated molded body 10, it is preferable that the porosity of a thin region 24, which is a bonding region with the resin member 40, be lower than the porosity of a thick region 25 of the porous base material.

In the present invention, the resin used for the resin member 40 is not limited to a particular resin, and the above-described thermoplastic resins or thermosetting resins can be used. Among them, a thermoplastic resin is preferable. The thermoplastic resin of the resin member 40 and the above-described thermoplastic resin base material are melted and fixed to form a bonding structure, and a higher bonding strength can be achieved as the integrated molded body 10. The melted and fixed bonding structure means a bonding structure in a state in which both members are melted by heat, cooled, and fixed. In particular, a PPS resin is more preferably used from the viewpoint of heat resistance and chemical resistance, a PC resin or a styrene-based resin is more preferably used from the viewpoint of molded article appearance and dimensional stability, and a PA resin is more preferably used from the viewpoint of strength and impact resistance of a molded article.

The resin included in the resin member 40 may further contain other fillers and additives in accordance with the required characteristics as long as the object of the present invention is not impaired. Examples thereof include inorganic fillers, flame retardants other than phosphorus-based flame retardants, conductivity imparting agents, crystal nucleating agents, ultraviolet absorbers, antioxidants, damping agents, antibacterial agents, insect repellents, deodorants, coloring inhibitors, heat stabilizers, mold release agents, antistatic agents, plasticizers, lubricants, coloring agents, pigments, dyes, foaming agents, antifoaming agents, and coupling agents.

Regarding the resin member 40, to achieve the light weight, high strength, and high stiffness of the integrated molded body 10, it is also preferred to use a resin containing reinforcing fibers. Examples of the reinforcing fibers that can be used include metal fibers such as aluminum fibers, brass fibers, and stainless steel fibers, PAN-based, rayon-based, lignin-based, and pitch-based carbon fibers and graphite fibers, inorganic fibers such as glass fibers, silicon carbide fibers, and silicon nitride fibers, and organic fibers such as aramid fibers, PBO fibers, PPS fibers, polyester fibers, acrylic fibers, nylon fibers, and PE fibers. The fiber value of the reinforcing fibers is preferably a fiber length that does not inhibit formation of a required unevenness shape and is 0.05 mm or more and 10 mm or less, more preferably 0.1 mm or more and 8 mm or less, still more preferably 0.2 mm or more and 5 mm or less. These reinforcing fibers may be used alone or in combination of two or more.

In particular, by using glass fibers, a function as a radio wave transmission member can be imparted to the frame member. In addition, by using carbon fibers, the thermal shrinkage of the resin itself can be suppressed, and deformation of the design surface due to shrinkage can be suppressed. In addition, by adopting the same configuration of a first frame member and a second frame member described below, it is possible to form a part of the resin member continuously with and integrally with the first frame member as illustrated in FIG. 7, for example.

The resin included in the resin member may further contain other fillers and additives in accordance with the required characteristics as long as the object of the present invention is not impaired. Examples thereof include fillers and additives similar to those contained in the resin member 40.

In the integrated molded body 10 of the present invention, one or two or more frame members disposed on an outer circumferential part of the laminate 20 and the resin member 40 are preferably integrated. As the material used for the frame members, a metal or a resin is preferably used. When a metal is used, frame members excellent in designability and high stiffness can be obtained. In addition, it is preferable to use a resin from the viewpoint of productivity, and a material that can be used as the resin member 40 described above can be used.

When a resin is used for the first and second frame members, the same resin types and reinforcing fibers, fillers, and additives as described above for the resin member can be used. Among them, the reinforcing fibers are preferably carbon fibers or glass fibers from the viewpoint of strength. By using glass fibers, a function as a radio wave transmission member can be imparted to the frame members. In addition, by using carbon fibers, the thermal shrinkage of the resin itself can be suppressed, and warpage can be reduced.

The reinforcing fibers used for the resin member, the first frame member, and the second frame member and the fiber mass contents thereof are preferably 1 to 60 wt % of discontinuous fibers. Using the fibers in the above range can increase bonding strength and reduce the warpage of the integrated molded body 10. When the fiber mass content is less than 1 wt %, it may be difficult to secure the strength of the integrated molded body 10, and when the fiber mass content is more than 60 wt %, filling of the resin in injection molding may be partially insufficient. From the viewpoint of moldability of the resin member, the fiber mass content is more preferably 5 to 55 wt %, still more preferably 8 to 50 wt %, particularly preferably 12 to 45 wt %.

Regarding the above-described overlapping part 60, the resin member is preferably provided with the overlapping part 60 in all directions in the in-plane direction.

A minimum thickness Tb of the overlapping part 60 is preferably 0.2 mm or more, more preferably 0.3 mm or more and 2.0 mm or less, still more preferably 0.5 mm or more and 1.0 mm or less. When the thickness Tb is 0.2 mm or more, a filling defect hardly occurs during injection molding. By setting the thickness Tb to 2.0 mm or less, the amount of the resin during injection molding is reduced, and deformation of the bonding region of the laminate 20 due to the resin temperature can be made less likely to occur. A portion having the minimum thickness Tb of the overlapping part 60 is preferably formed at a location farthest in the in-plane direction from the wall surface of the through-hole 30 of the laminate 20. By adopting such a configuration, the integrated molded body is easily formed from the viewpoint of flowability of the resin.

The length (overlap length) of the overlapping part 60 in the in-plane direction from the wall surface portion of the through-hole is preferably 1.0 mm or more and 100 mm or less, more preferably 2.0 mm or more and 50 mm or less, still more preferably 3.0 mm or more and 20 mm or less from the viewpoint of the bonding strength between the laminate and the resin member.

In the integrated molded body of the present invention, a maximum thickness Ta of the overlapping part 60 is not particularly limited, but a total thickness of the laminate and the overlapping part in the bonding region between the laminate and the overlapping part is preferably thinner than the thickness of the laminate in a non-bonding region with the overlapping part. By adopting such a configuration, the integrated molded body is less likely to interfere with other components when used as an electronic product, and a preferable integrated molded body is easily obtained from the viewpoint of product design. More specifically, with reference to FIG. 3, in the case where the laminate 20 includes the thin section 24 and the thickened section 25 and where the thin section 24 has a bonding region with the overlapping part 60, a maximum thickness 26 of the bonding region or the resin member is preferably smaller than a thickness 27 of the thickened section 25 in the non-bonding region.

The ratio Tb/Ta of the maximum thickness Ta (mm) and the minimum thickness Tb (mm) of the overlapping part 60 is preferably more than 0 and less than 1, more preferably more than 0 and 0.8 or less, still more preferably more than 0 and 0.5 or less. By setting the ratio Tb/Ta to be less than 1, the strength of the integrated molded body can be easily maintained at the maximum thickness portion, and the pressure and the like required for injection molding at the minimum thickness portion can be reduced, so that the load such as the pressure applied to the laminate is further reduced, and the occurrence of appearance defects can be easily prevented.

In addition, the shape of the resin member 40 formed by the portions corresponding to the minimum thickness Tb and the maximum thickness Ta of the overlapping part 60 may not be a uniform straight line. The shape of the resin member 40 may be, for example, a shape that forms an arc as illustrated in FIG. 4, or a unevenness area may be formed according to the application within a range not exceeding the thickness range of the minimum thickness Tb and the maximum thickness Ta.

Further, when the resin member 40 is formed, a structure in which the resin member 40 and the frame member or a part of the frame member are integrated may be formed by one injection molding by forming a structure in which the resin member 40 is integrated with the frame member in all or a part of the directions in the in-plane direction at the overlapping part 60.

With respect to the shape of the unevenness area 50 on the exposed surface on the design surface side of the resin member 40, the resin member 40 may be convex in the thickness-direction of the laminate 20 with respect to the design surface. However, when the resin member 40 is used for an electronic equipment casing or the like, it is preferable not to be convex from the viewpoint of surface smoothness. The height difference of the unevenness area 50 is preferably 0.1 mm to 10 mm, more preferably 0.1 mm to 1.0 mm from the viewpoint of the thickness of the integrated molded body 10.

Furthermore, in the configuration of the frame member, as illustrated in FIG. 7, separately providing a first frame member 80 and a second frame member 90, disposing the second frame member 90 at an outer circumferential part of the laminate 20 in advance, and then performing injection molding of the first frame member 80 is also effective for reducing warpage of the integrated molded body 10.

When a resin is used for the frame member, as described above, a function can be imparted to the resin by the reinforcing fibers, and by making the types of reinforcing fibers used for the first frame member 80 and the second frame member 90 different, the respective characteristics can be effectively utilized. For example, when carbon fibers are used for the first frame member 80 and glass fibers are used for the second frame member 90, a design with low warpage and excellent antenna performance can be made.

When a resin is used for the frame member of the laminate 20 having a foamed molded body as the core layer 22, it is preferable to have a fitted-in portion that enters the laminate 20 in a part of the frame member from the viewpoint of the bonding strength of the integrated molded body 10. This is because the bonding strength between the laminate 20 and the frame member can be further enhanced by the anchoring effect by having the fitted-in portion. When the frame member is formed by injection molding, the frame member is bonded with the flat surface portion or the side surface portion of the prepreg layers of the laminate 20, and the frame member can enter a partial region in the core layer 22 from the side surface portion of the laminate 20 by injection molding pressure. This is because the region in the core layer 22 is highly porous, and is configured to allow the molten frame member to easily penetrate. In addition, by using the porous base material for the core layer 22, the bonding strength due to the anchoring effect can be further enhanced.

For each of the above-described materials, a recycled material may be used according to required characteristics from the viewpoint of reducing the environmental load as long as the object of the present invention is not impaired.

Each of the above-described materials can be effectively used in interiors and exteriors of motor vehicles, electronic equipment casings, bicycles, structural materials for sports goods, aircraft interior materials, transportation boxes, and the like. Among them, the integrated molded body of the present invention is preferably used as an electronic equipment casing. By using the integrated molded body as an electronic equipment casing, characteristics such as thinning, high stiffness, and high design of a product can be effectively utilized.

The upper limits and the lower limits of the numerical ranges described above can be arbitrarily combined unless otherwise specified.

### EXAMPLES

Hereinafter, the integrated molded body of the present invention and a method for producing the same will be specifically described with reference to Examples, but the following Examples do not limit the present invention.

### (1) Appearance Evaluation

Under an indoor fluorescent lamp environment, the periphery of the exposed surface of the resin member 40 of the integrated molded body 10 obtained in each of Examples and Comparative Examples was visually inspected, and when deformation and color unevenness were visually recognized, it was judged to be unacceptable, and when deformation and color unevenness were not visually recognized, it was judged to be acceptable.

### (Material Composition Example 1) Preparation of PAN-Based Carbon Fiber Bundle

A polymer with PAN as a main component was subjected to spinning and calcining processing to obtain a continuous carbon fiber bundle having a total number of filaments of 12,000 (12K). A sizing agent was imparted to the continuous carbon fiber bundle by an immersion method, and the continuous carbon fiber bundle was dried in heated air to obtain a PAN-based carbon fiber bundle. This PAN-based carbon fiber bundle had the following properties.
Single filament diameter; 7 μm
Mass per unit length: 0.83 g/m
Density: 1.8 g/cm³
Tensile strength: 4.0 GPa
Tensile modulus: 235 GPa

### (Material Composition Example 2) Preparation of Epoxy Resin Film

An epoxy resin (base resin: dicyandiamide/dichlorophenylmethylurea-curing epoxy resin) was applied to release paper using a knife coater to obtain an epoxy resin film.

### (Material Composition Example 3) Preparation of Unidirectional Prepreg

The PAN-based carbon fiber bundles obtained in Material Composition Example 1 were arranged in one direction in the form of a sheet, both surfaces of the carbon fiber sheet were covered with two epoxy resin films produced in Material Composition Example 2 respectively, the resulting product was heated and pressurized to impregnate the carbon fiber bundles with the resin to produce a unidirectional prepreg having a carbon fiber mass content of 70% and a thickness of 0.15 mm.

### (Material Composition Example 4) Foamed Molded Body

A non-cross-linked PP sheet with low foaming ratio “EFCELL” (registered trademark) (double expansion) (manufactured by Furukawa Electric Co., Ltd.) was used.

### (Material Composition Example 5) Chopped Carbon Fiber Bundle

PAN-based carbon fibers (“TORAYCA” (registered trademark) manufactured by Toray Industries, Inc., product name: T700SC) were cut with a cartridge cutter to obtain chopped carbon fiber bundles having a fiber length of 6 mm.

### (Material Composition Example 6) Carbon Fiber Mat

A 1.5 wt % aqueous solution (100 liters) of a surfactant (“sodium n-dodecylbenzenesulfonate” (product name) manufactured by Wako Pure Chemical Industries, Ltd.) was stirred to prepare a pre-bubbled dispersion. The chopped carbon fiber bundles obtained in Material Composition Example 5 were put into the dispersion and stirred. The resulting mixture was poured into a paper machine having a paper surface having a length of 400 mm and a width of 400 mm, dehydrated by suction, and then dried at 150° C. for 2 hours to obtain a carbon fiber mat. The obtained mat was in a good dispersion state.

### (Material Composition Example 7) PP Resin Film

Dry blending of 90 wt % of an unmodified PP resin (“Prime Polypro” (registered trademark) J105G manufactured by Prime Polymer Co., Ltd., melting point: 160° C.) and 10 wt % of an acid-modified PP resin (“ADMER” (registered trademark) QE510 manufactured by Mitsui Chemicals, Inc., melting point: 160° C.) was performed to obtain a dry blend resin. A PP resin film was obtained using the dry blend resin.

### (Material Composition Example 8) Porous Base Material

The materials obtained in Material Composition Example 6 and Material Composition Example 7 were used for lamination in the order of “PP resin film/carbon fiber mat/PP resin film” to obtain a porous base material.

### (Material Composition Example 9) Glass Fiber-Reinforced PC Resin

Glass fiber-reinforced PC compound pellets (“Panlite” (registered trademark) GXV-3545WI (manufactured by Teijin Chemicals Ltd.)) were used.

### (Material Composition Example 10) PC Resin

A PC resin (“Panlite” (registered trademark) L-1225L manufactured by Teijin Chemicals Ltd.) was used.

### (Material Composition Example 11) Pellet-Shaped CF-Reinforced PC Resin

The PAN-based carbon fiber bundles obtained in Material Composition Example 1 were arranged in one direction in the form of a sheet and impregnated with an epoxy resin composition having the same composition as that in Material Composition Example 2, and the resulting resin-impregnated reinforcing fiber bundles were conveyed in the fiber direction and passed through a coating die for a wire coating method installed at the tip of a TEX-30 type twin screw extruder manufactured by The Japan Steel Works, Ltd. The PC resin of Material Composition Example 10 was supplied from a main hopper of the TEX-30x type twin screw extruder, melt-kneaded, discharged in a molten state into the die, and continuously disposed so as to cover the periphery of the resin-impregnated reinforcing fiber bundles. The obtained continuous molding material was cooled and then cut with a cutter to obtain a pellet-shaped CF-reinforced PC resin (fiber mass content: 20 wt %) having a length in the fiber orientation direction of 7 mm.

### (Material Composition Example 12) Thermoplastic Resin Base Material

A polyester resin film having a thickness of 0.05 mm was obtained using a polyester resin (“Hytrel” (registered trademark) manufactured by DU PONT-TORAY CO., LTD.). The obtained film was used as the thermoplastic resin base material.

### Example 1

The unidirectional prepreg prepared in Material Composition Example 3 and the thermoplastic resin base material prepared in Material Composition Example 12 were each adjusted to a square size of 400 mm×400 mm, laminated in the order of “unidirectional prepreg 0°/unidirectional prepreg 90°/unidirectional prepreg 0°/unidirectional prepreg 90°/unidirectional prepreg 0°/thermoplastic resin base material”, and press-molded in a flat mold heated to 150° C. under the condition of 3 MPa for 5 minutes to obtain a laminate 20.

Subsequently, the obtained laminate 20 was cut into a square size of 300 mm×200 mm, and a through-hole 30 of a square size of 20 mm×10 mm was formed. The laminate 20 was set in an injection mold, and the glass fiber-reinforced PC of Material Composition Example 9 was injection-molded under the conditions of 150 MPa, a cylinder temperature of 320° C., a mold temperature of 120° C., and a diameter of the resin discharge port of 3 mm to form a resin member 40 (Tb: 0.10 mm, Ta: 0.20 mm, minimum overlap length: 3.0 mm) including a part that has in the through-hole 30 a surface exposed from the design surface side of the laminate 20 and is bonded to the wall surface of the through-hole 30 and an overlapping part bonded to the non-design surface side of the laminate 20, thereby producing an integrated molded body 10. Finally, coating with different colors was performed on a recess and portions other than the recess on the design surface side of the integrated molded body 10. As a result of appearance evaluation of the obtained integrated molded body 10 by the method described above, it was judged as acceptable.

### Example 2

The unidirectional prepreg prepared in Material Composition Example 3, the foamed molded body prepared in Material Composition Example 4, and the thermoplastic resin base material prepared in Material Composition Example 12 were each adjusted to a square size of 400 mm×400 mm, laminated in the order of “unidirectional prepreg 0°/unidirectional prepreg 90°/foamed molded body/unidirectional prepreg 90°/unidirectional prepreg 0°/thermoplastic resin base material”, and press-molded in a flat mold heated to 150° C. under the condition of 2 MPa for 5 minutes to obtain a laminate 20.

Subsequently, the obtained laminate 20 was cut into a square size of 300 mm×200 mm, and a through-hole 30 having the same dimensions and shape as in Example 1 was formed. The laminate 20 was set in an injection mold, and the glass fiber-reinforced PC of Material Composition Example 9 was injection-molded under the same conditions and apparatus as in Example 1 to form a resin member 40 (Tb: 0.30 mm, Ta: 0.40 mm, minimum overlap length: 2.0 mm) around the through-hole 30, thereby producing an integrated molded body 10. As a result of the appearance evaluation, it was judged as acceptable.

### Example 3

The unidirectional prepreg prepared in Material Composition Example 3, the porous base material prepared in Material Composition Example 8, and the thermoplastic resin base material prepared in Material Composition Example 12 were each adjusted to a square size of 400 mm×400 mm, laminated in the order of “unidirectional prepreg 0°/unidirectional prepreg 90°/porous base material/unidirectional prepreg 90°/unidirectional prepreg 0°/thermoplastic resin base material”, and press-molded in a flat mold heated to 150° C. under the condition of 3 MPa for 5 minutes to obtain a laminate 20 precursor. Thereafter, the laminate 20 precursor was heated at 180° C. and molded with a press mold having a three-dimensional shape at 120° C. to obtain a laminate 20.

Subsequently, the obtained laminate 20 was cut into a square size of 300 mm×200 mm, and a through-hole 30 having the same dimensions and shape as in Example 1 was formed. The laminate 20 was set in an injection mold, and the glass fiber-reinforced PC of Material Composition Example 9 was injection-molded under the same conditions and apparatus as in Example 1 to form a resin member 40 (Tb: 0.50 mm, Ta: 1.00 mm, minimum overlap length: 1.5 mm) around the through-hole 30, thereby producing an integrated molded body 10. As a result of the appearance evaluation, it was judged as acceptable.

### Example 4

The same materials as in Example 2 were each adjusted to a square size of 400 mm×400 mm, then laminated in the same order as in Example 2, and press-molded under the same conditions as in Example 2 to obtain a laminate 20.

Subsequently, the obtained laminate 20 was cut into a square size of 300 mm×200 mm, and a through-hole 30 having the same dimensions and shape as in Example 1 was formed. The laminate 20 was set in an injection mold, and the glass fiber-reinforced PC of Material Composition Example 9 was injection-molded under the same conditions and apparatus as in Example 1 to form a resin member 40 (Tb: 0.50 mm, Ta: 1.50 mm, minimum overlap length: 5.0 mm) around the through-hole 30. Thereafter, the same glass fiber-reinforced PC resin was injected using another injection mold to form a frame member on the outer circumferential part of the laminate 20, thereby producing an integrated molded body 10. As a result of the appearance evaluation, it was judged as acceptable.

### Example 5

The same materials as in Example 3 were each adjusted to a square size of 400 mm×400 mm, then laminated in the same order as in Example 3, and press-molded and heated under the same conditions as in Example 3 to obtain a laminate 20.

Subsequently, the obtained laminate 20 was cut into a square size of 300 mm×200 mm, and a through-hole 30 having the same dimensions and shape as in Example 1 was formed. Thereafter, a second frame member was produced in advance using the glass fiber-reinforced PC of Material Composition Example 9, and the second frame member and the laminate 20 were set in an injection mold. Using the CF-reinforced PC resin of Material Composition Example 11, injection molding was performed under the same conditions and with the same apparatus as in Example 1, and a resin member 40 (Tb: 0.70 mm, Ta: 0.80 mm, minimum overlap length: 8.0 mm) and a first frame member were integrally formed around the through-hole 30 as a continuous shape in certain directions to produce an integrated molded body 10. As a result of the appearance evaluation, it was judged as acceptable.

### Example 6

The same materials as in Example 3 were each adjusted to a square size of 400 mm×400 mm, then laminated in the same order as in Example 3, and press-molded and heated under the same conditions as in Example 3 to obtain a laminate 20.

Subsequently, the obtained laminate 20 was cut into a square size of 300 mm×200 mm, a through-hole 30 having the same dimensions and shape as in Example 1 was formed, and a notch 70 was formed on the design surface side. Thereafter, a second frame member was produced using the glass fiber-reinforced PC of Material Composition Example 9 in advance, the second frame member and the laminate 20 were set in an injection mold, and the glass fiber-reinforced PC of Material Composition Example 9 was used for injection molding under the same conditions and apparatus as in Example 1 to form a resin member 40 (Tb: 0.30 mm, Ta: 1.00 mm, minimum overlap length: 2.5 mm) and a frame member shape around the through-hole 30, thereby producing an integrated molded body 10. As a result of the appearance evaluation, it was judged as acceptable.

### Example 7

The same materials as in Example 3 were each adjusted to a square size of 400 mm×400 mm, then laminated in the same order as in Example 3, and press-molded and heated under the same conditions as in Example 3 to obtain a laminate 20.

Subsequently, the obtained laminate 20 was cut into a square size of 300 mm×200 mm, a through-hole 30 having the same dimensions and shape as in Example 1 was formed, and a notch 70 was formed on the non-design surface side. Thereafter, a second frame member was produced using the CF fiber-reinforced PC of Material Composition Example 11 in advance, the second frame member and the laminate 20 were set in an injection mold, and the glass fiber-reinforced PC of Material Composition Example 9 was used for injection molding under the same conditions and apparatus as in Example 1 to form a resin member 40 (Tb: 0.30 mm, Ta: 1.50 mm, minimum overlap length: 10.0 mm) and a frame member shape around the through-hole 30, thereby producing an integrated molded body 10. As a result of the appearance evaluation, it was judged as acceptable.

### Comparative Example 1

The same materials as in Example 3 were each adjusted to a square size of 400 mm×400 mm, then laminated in the same order as in Example 3, and press-molded and heated under the same conditions as in Example 3 to obtain a laminate 20.

Subsequently, the obtained laminate 20 was cut into a square size of 300 mm×200 mm, and a through-hole 30 having the same dimensions and shape as in Example 1 was formed. Thereafter, the laminate 20 was set in an injection mold, and the glass fiber-reinforced PC of Material Composition Example 9 was used for injection molding under the same conditions and apparatus as in Example 1 to form a resin member 40 (Tb: 0.05 mm, Ta: 1.5 mm, overlap length: (in all directions) 0 mm) around the through-hole 30, thereby producing an integrated molded body 10. As a result of the appearance evaluation, since the resin member 40 had no overlapping part to be bonded to the non-design surface side outer layer, the resin member was detached from the laminate 20 due to insufficient bonding strength, and the integrated molded body 10 was not obtained.

### Comparative Example 2

The same materials as in Example 3 were each adjusted to a square size of 400 mm×400 mm, then laminated in the same order as in Example 3, and press-molded and heated under the same conditions as in Example 3 using a press mold in which the unevenness area 50 was formed, thereby obtaining a laminate 20.

Subsequently, the obtained laminate 20 was cut into a square size of 300 mm×200 mm, then the laminate 20 was set in an injection mold, and the glass fiber-reinforced PC of Material Composition Example 9 was used for injection molding under the same conditions and apparatus as in Example 1 around the laminate 20 to form a frame member, thereby producing an integrated molded body 10. As a result of the appearance evaluation of the obtained integrated molded body 10 by the method described above, damage of the laminate 20 was observed around the part in which the unevenness area 50 was formed on the surface of the laminate 20, and it was determined as unacceptable.

The configuration and characteristics of the integrated molded bodies 10 obtained in above Examples and Comparative Examples are collectively shown in Table 1.

TABLE 1-1

| | | Example 1 | Example 2 | Example 3 | Example 4 | Example 5 |
|---|---|---|---|---|---|---|
| Lamination | Skin layer | Material | Material | Material | Material | Material |
| step | | Composition | Composition | Composition | Composition | Composition |
| | | Example 3 | Example 3 | Example 3 | Example 3 | Example 3 |
| | Core layer | Absent | Material | Material | Material | Material |
| | | | Composition | Composition | Composition | Composition |
| | | | Example 4 | Example 8 | Example 4 | Example 8 |
| Notch | | Absent | Absent | Absent | Absent | Absent |
| Injection | Resin member | Material | Material | Material | Material | Material |
| molded | | Composition | Composition | Composition | Composition | Composition |
| article | | Example 9 | Example 9 | Example 9 | Example 9 | Example 11 |
| | First frame | Absent | Absent | Absent | Material | Material |
| | member | | | | Composition | Composition |
| | | | | | Example 9 | Example 11 |
| | Second frame | Absent | Absent | Absent | Absent | Material |
| | member | | | | | Composition |
| | | | | | | Example 9 |
| Parameter | Tb [mm] | 0.10 | 0.30 | 0.50 | 0.50 | 0.70 |
| | Ta [mm] | 0.20 | 0.40 | 1.00 | 1.50 | 0.80 |
| | Tb/Ta | 0.50 | 0.75 | 0.50 | 0.33 | 0.88 |

| | | | | | |
|---|---|---|---|---|---|
| Appearance evaluation | Acceptable | Acceptable | Acceptable | Acceptable | Acceptable |

TABLE 1-2

| | | | | Comparative | Comparative |
|---|---|---|---|---|---|
| | | Example 6 | Example 7 | Example 1 | Example 2 |
| Lamination | Skin layer | Material | Material | Material | Material |
| step | | Composition | Composition | Composition | Composition |
| | | Example 3 | Example 3 | Example 3 | Example 3 |
| | Core layer | Material | Material | Material | Material |
| | | Composition | Composition | Composition | Composition |
| | | Example 8 | Example 8 | Example 8 | Example 8 |
| Notch | | Design | Non-design | Absent | Absent |
| | | surface side | surface side | | |
| Injection | Resin member | Material | Material | Material | Material |
| molded | | Composition | Composition | Composition | Composition |
| article | | Example 9 | Example 11 | Example 9 | Example 9 |
| | First frame | Material | Material | Absent | Material |
| | member | Composition | Composition | | Composition |
| | | Example 9 | Example 11 | | Example 9 |
| | Second frame | Material | Material | Absent | Absent |
| | member | Composition | Composition | | |
| | | Example 9 | Example 9 | | |
| Parameter | Tb [mm] | 0.30 | 0.30 | 0.05 | 0.50 |
| | Ta [mm] | 1.00 | 1.50 | 1.50 | 0.30 |
| | Tb/Ta | 0.30 | 0.20 | 0.03 | 1.67 |

| | | | | |
|---|---|---|---|---|
| Appearance evaluation | Acceptable | Acceptable | Failed | Failed |

### INDUSTRIAL APPLICABILITY

The integrated molded body according to the present invention can be effectively used in interiors and exteriors of motor vehicles, electronic equipment casings, bicycles, structural materials for sports goods, aircraft interior materials, transportation boxes, and the like.

### DESCRIPTION OF REFERENCE SIGNS

10: Integrated molded body
20: Laminate
21: Skin layer (design surface side)
22: Core layer
23: Skin layer (non-design surface side)
24: Thin section of laminate
25: Thickened section of laminate
26: Thickest section of bonding region or resin member
27: Thickness of thickened section 25
30: Through-hole
31: Width of through-hole
40: Resin member
50: Unevenness area
60: Overlapping section
70: Notch in wall surface of through-hole in laminate
80: First frame member
90: Second frame member
100: Design surface
110: Non-design surface

1. An integrated molded body comprising:
a laminate including a prepreg layer consist of a continuous fiber and a resin; and
a resin member integrated with the laminate,
wherein in the laminate, one surface in a thickness-direction is on a design surface side, and a surface opposite to the surface on the design surface side is on a non-design surface side,
the laminate has a through-hole penetrating in the thickness-direction, and
the resin member has a part having an exposed surface from the through-hole of a design surface side outer layer of the laminate, and an overlapping part with the laminate, the overlapping part being bonded to a non-design surface side outer layer of the laminate.

2. The integrated molded body according to claim 1, wherein a minimum thickness Tb of the overlapping part is 0.2 mm or more.

3. The integrated molded body according to claim 1, wherein a portion having a minimum thickness Tb of the overlapping part is formed at a position farthest in an in-plane direction from a wall surface of the through-hole of the laminate.

4. The integrated molded body according to claim 3, wherein a ratio Tb/Ta between a maximum thickness Ta (mm) and the minimum thickness Tb (mm) of the overlapping part is larger than 0 and smaller than 1.

5. The integrated molded body according to claim 1, wherein a total thickness of the laminate and the overlapping part in a bonding region between the laminate and the overlapping part is thinner than a thickness of the laminate in a non-bonding region with the overlapping part.

6. The integrated molded body according to claim 1, having a unevenness area on a surface of a part including the exposed surface.

7. The integrated molded body according to claim 6, wherein a maximum depth of a recess of the unevenness area is 0.1 mm or more and 10 mm or less from a surface on the design surface side.

8. The integrated molded body according to claim 1, wherein one or two or more frame members disposed on an outer circumferential part of the laminate and the resin member are integrated.

9. The integrated molded body according to claim 1, having a notch in a wall surface of the through-hole in the laminate.

10. The integrated molded body according to claim 6, wherein the unevenness area is provided with a design different from a surrounding portion, and the unevenness area forms a character or a pattern.

11. The integrated molded body according to claim 10, wherein the unevenness area forms a logo.

12. The integrated molded body according to claim 1 that is used as an electronic equipment casing.
